(19) United States
(12) Patent Application Publication
(10) Pub. No.: US 2007/0160337 A1
(43) Pub. Date: Jul. 12, 2007

(54) Planar light waveguide and method of manufacturing same

(75) Inventors: In Kim, Suwon-si (KR); Young-Hyun Kim, Yeongtong-dong (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/505,139

(22) Filed: Aug. 16, 2006

(30) Foreign Application Priority Data
Jan. 12, 2006 (KR) 3626/2006

(51) Int. Cl. G02B 6/10

(52) U.S. Cl. 385/131; 385/129

(57) ABSTRACT

A planar light waveguide includes at least two cores, which are transmission media of optical signals, a clad surrounding the cores and guiding the optical signals inside the cores, and a dummy core located between the cores.

### CLAIM OF PRIORITY

This application claims the benefit of the earlier filing date, pursuant to 35 U.S.C. §119, to that patent application entitled “Planar Light Waveguide” filed in the Korean Intellectual Property Office on Jan. 12, 2006 and assigned Serial No. 2006-3626, the contents of which are incorporated herein by reference.

### BACKGROUND OF THE INVENTION

1. Field of the Invention

The present invention relates generally to a planar light waveguide, and in particular, to a planar light waveguide for suppressing interference between optical signals and crosstalk due to the interference.

2. Description of the Related Art

FIG. 1 is a schematic diagram of a conventional optical connection structure 10 for the transmission of independent upstream/downstream clock and data. Referring to FIG. 1, the conventional optical connection structure 10 includes a first light source 11b for transmitting upstream data, a second light source 11a for transmitting a clock of the upstream data, a first optical detector 12b for detecting the upstream data, a second optical detector 12a for detecting the clock of the upstream data, a third light source 14b for transmitting downstream data, a fourth light source 14a for transmitting a clock of the downstream data, a third optical detector 13b for detecting the downstream data, and a fourth optical detector 13a for detecting the clock of the downstream data.

A laser diode (LD) can be used for the light sources 11b, 11a, 14b, and 14a, and a photo diode (PD) can be used for the optical detectors 12b, 12a, 13b, and 13a. The light sources 11a, 11b, 14b, and 14a and the optical detectors 12b, 12a, 13b, and 13a can be connected to each other through optical waveguides, respectively.

FIG. 2 illustrates a schematic configuration of an optical transceiver 20 for explaining the occurrence of crosstalk due to interference and dispersion when data and clock signals are transmitted using a single planar light waveguide in optical transmission and reception. Referring to FIG. 2, the optical transceiver 20 includes a planar light waveguide 25 for propagating an optical signal 2, first and second light sources 21 and 22 for generating the optical signal 2 and a clock signal 1 associated with the optical signal 2, respectively, and first and second optical detectors 23 and 24 for detecting the optical signal 2 and the clock signal 1, respectively.

The planar light waveguide 25 includes a first core 25b, which is a transmission medium of the optical signal 2, a second core 25a, which is a transmission medium of the clock signal 1, and a clad surrounding the first and second cores 25b and 25a.

The first light source 21 outputs the optical signal 2 to the first optical detector 23 through the first core 25b. The second light source 22 outputs the clock signal 1 to the second optical detector 24 through the second core 25a.

However, portions 3 and 4, which cannot be incident to relevant cores, out of the clock signal 1 generated by the second light source 22 travel through the clad between the first and second cores 25b and 25a and causes interference, e.g., delayed arrival of dispersed clock signal 1 in the second optical detector 24 and crosstalk with the optical signal 2 in the first optical detector 23, thereby resulting in a mis-operation. In addition, a portion 5 of the clock signal 1 transmitted through the second core 25a may be coupled with the optical signal 2 due to diffraction of the clock signal 1 at the output of the second core 25a. A similar argument can be applied to unintentional coupling of the optical signal 1 generated by the first light source 21 to the clock signal 2.

FIGS. 3A and 3B are graphs for comparing a case where an optical signal and the center of a core match each other to a case where they do not match each other in a conventional optical transceiver. The x-axis of FIGS. 3A and 3B indicates the width of a planar light waveguide, the letter “0” indicates the center, and the z-axis indicates an optical signal traveling direction perpendicular to the x-axis. As illustrated in FIG. 3B, if an optical signal incident to one core does not match the core, the other core is significantly affected. In addition, as illustrated in FIG. 3A, even if the optical signal incident to one core matches the core, a portion of the optical signal affects the other core due to a mode mismatch between a light source and the core.

### SUMMARY OF THE INVENTION

An object of the present invention is to substantially solve at least the above problems and/or its disadvantages and provides additional advantages, by providing a planar light waveguide for minimizing crosstalk and which is easy to manufacture.

According to one aspect of the present invention, there is provided a planar light waveguide comprising more than two cores, which are transmission media of optical signals, a clad surrounding the cores and guiding the optical signals inside the cores, and a dummy core located between the cores.

### BRIEF DESCRIPTION OF THE DRAWINGS

The above features and advantages of the present invention will become more apparent from the following detailed description when taken in conjunction with the accompanying drawing in which:

FIG. 1 is a schematic diagram of a conventional optical connection structure;

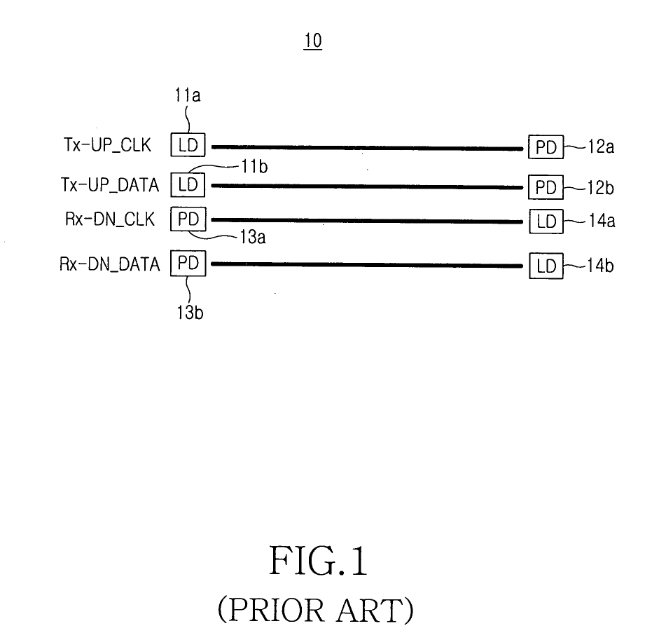

FIG. 2 is a schematic configuration of a conventional optical transceiver for optical transmission and reception of data and clock signals;

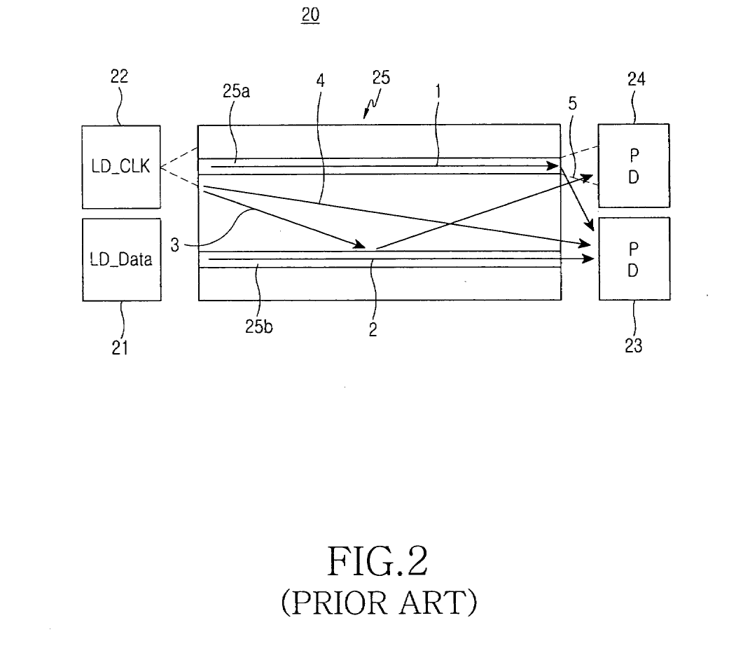

FIGS. 3A and 3B are graphs for comparing a case where an optical signal and a core matches each other to a case where they do not match each other in a conventional optical transceiver;

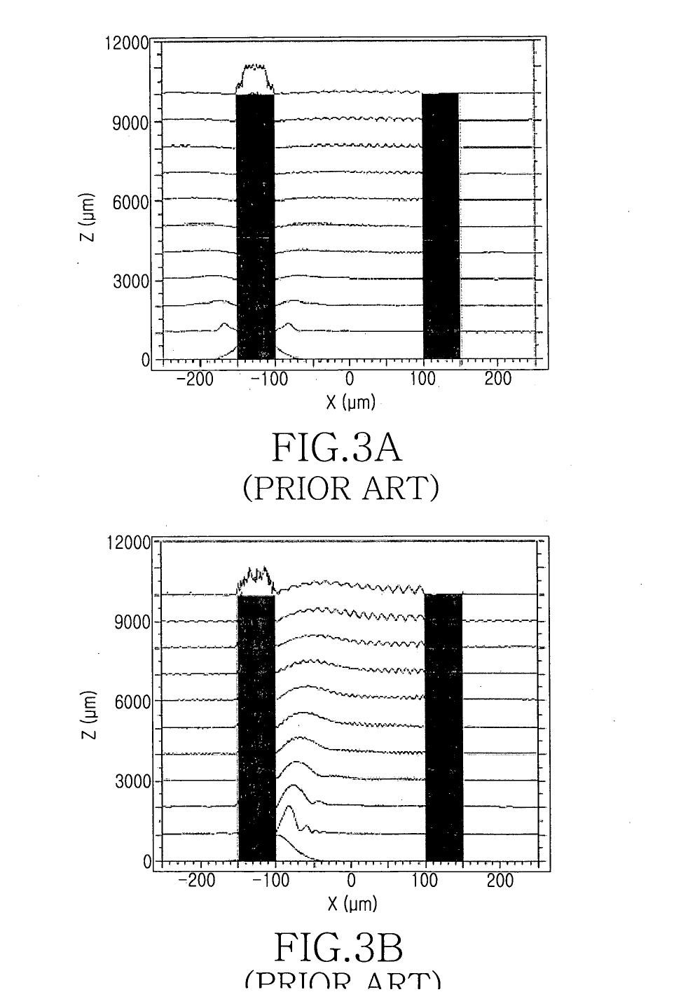

FIGS. 4A to 4D are perspective views of the manufacturing steps of planar light waveguide in according to a first preferred embodiment of the present invention;

FIG. 5 is a perspective view of a planar light waveguide having a second structure, which is completed according to the manufacturing steps of FIGS. 4A to 4C;

FIG. 6 is a schematic configuration of an optical transceiver including a planar light waveguide according to a second exemplary embodiment of the present invention;

FIGS. 7A and 7B are graphs for comparing a case where an optical signal and a core matches each other to a case where they do not match each other in the optical transceiver of FIG. 6;

FIG. 8 is a schematic configuration of an optical transceiver including a planar light waveguide according to a third exemplary embodiment of the present invention;

FIG. 9 is a perspective view of the planar light waveguide of FIG. 8; and

FIG. 10 is a schematic configuration of an optical transceiver including a planar light waveguide according to a fourth preferred embodiment of the present invention.

### DETAILED DESCRIPTION OF THE INVENTION

Now, embodiments of the present invention will be described herein below with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

The present invention relates to an optical connection structure, and a planar light waveguide according to a preferred embodiment of the present invention includes a plurality of cores for transmitting/receiving optical signals, a dummy core located between the cores, and a clad surrounding the cores. The clad can be configured to include a first clad in which the cores and the dummy core are formed and a second clad grown on a substrate to include the first clad. The first clad can be formed by using a portion of the substrate or by a separate growth.

Each of the cores transmits an optical signal generated by a relevant light source. However, the dummy core is located between the cores, suppresses interference occurring when a portion of an optical signal, which is not incident to a relevant core, is incident to the adjacent clad, and minimizes errors and losses due to the interference.

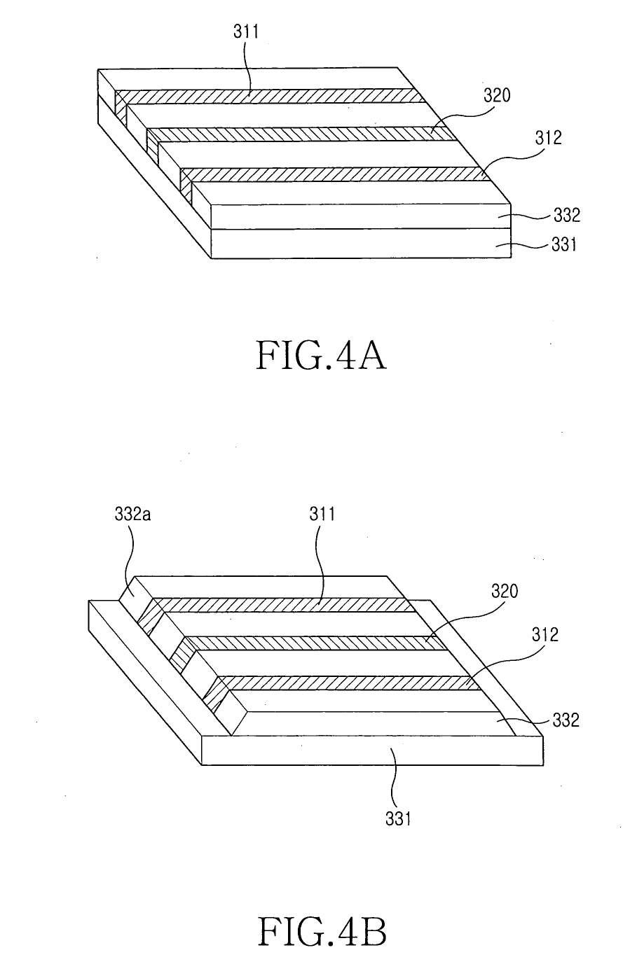

FIGS. 4A to 4D illustrate perspective views of the manufacturing steps of a planar light waveguide according to a first preferred embodiment of the present invention. The planar light waveguide according to the current embodiment includes a substrate 331, at least two cores 311 and 312, which are formed on the substrate 331 and are transmission media of optical signals, first and second cladding layers 332 and 333 surrounding the cores 311 and 312 and guiding the optical signals inside the enclosed cores 311 and 312, and a dummy core 320 located between the cores 311 and 312.

FIG. 4A shows a first state where the cores 311 and 312 and the dummy core 320 formed between the cores 311 and 312 are formed on the first clad 332 grown on the substrate 331. The first clad 332 can be formed on the substrate 331, or the substrate 331 can be used for the first clad 332. The cores 311 and 312 and the dummy core 320 are formed by separately forming each other offset by a predetermined distance.

The cores 311 and 312 and the dummy core 320 are separated in parallel to each other and can be formed by growing a core material in an etched portion of the first clad 332.

FIG. 4B shows a state where inclined planes 332a having a predetermined angle are formed on both ends of the first clad 332, and FIG. 4C shows a state where reflective mirrors 341, 342, 343, and 344 are formed on both ends of the cores 311 and 312, which are exposed on the inclined planes 332a.

Each of the reflective mirrors 341, 342, 343, and 344 is formed to cover a portion of the relevant core 311,312 exposed on the inclined planes 332a and changes the path of an optical signal traveling inside the respective relevant core 311, 312. However, the current embodiment does not form any reflective mirror on the exposed portion of the inclined planes 332a for the dummy core 320, thereby minimizing the occurrence of interference between optical signals, which are not coupled with the relevant core 311, 312.

FIG. 4D is a perspective view of a planar light waveguide 300 completed through the manufacturing steps of FIGS. 4A to 4C. According to the planar light waveguide 300 illustrated in FIG. 4D, the second clad 333 covering the first clad 332 is grown on the substrate 331, and absorption layers 350 and 360 are formed on the second clad 333 to correspond to the reflective mirrors 341 and 342 in the transmission side and the reflective mirrors 343 and 344 in the reception side.

The absorption layers 350 and 360 absorb optical signals that have not been blocked by the dummy core 320, among optical signals not incident to the respective cores 311 and 312. According, the occurrence of interference due to the optical signals is minimized.

The planar light waveguide 300 illustrated in FIG. 4D can be used to input and/or output an optical signal using each of the reflective mirrors 341, 342, 343, and 344 combined with a light source or an optical detector located therebelow and facing them. That is, each of the reflective mirrors 341, 342, 343, and 344 can reflect an incident optical signal to the respective relevant core 311, 312, or reflect an optical signal guided through the relevant core 311, 312 to a light source or an optical detector.

The planar light waveguide 300 according to the current embodiment can be manufactured with various sizes if necessary. For example, the planar light waveguide 300 can be designed with a 100 μm distance between each of the cores 311 and 312 and the dummy core 320 and a 50 μm width of each of the cores 311, 312, and 320. Accordingly, the width of the planar light waveguide 300 can be 250 μm. However, the width of the planar light waveguide 300 can be variously selected according to the number of cores and dummy cores. The inclined planes 332a can be formed with a substantially 450 slope and can be adjusted according to the efficiency of optical signal coupling and the structural needs.

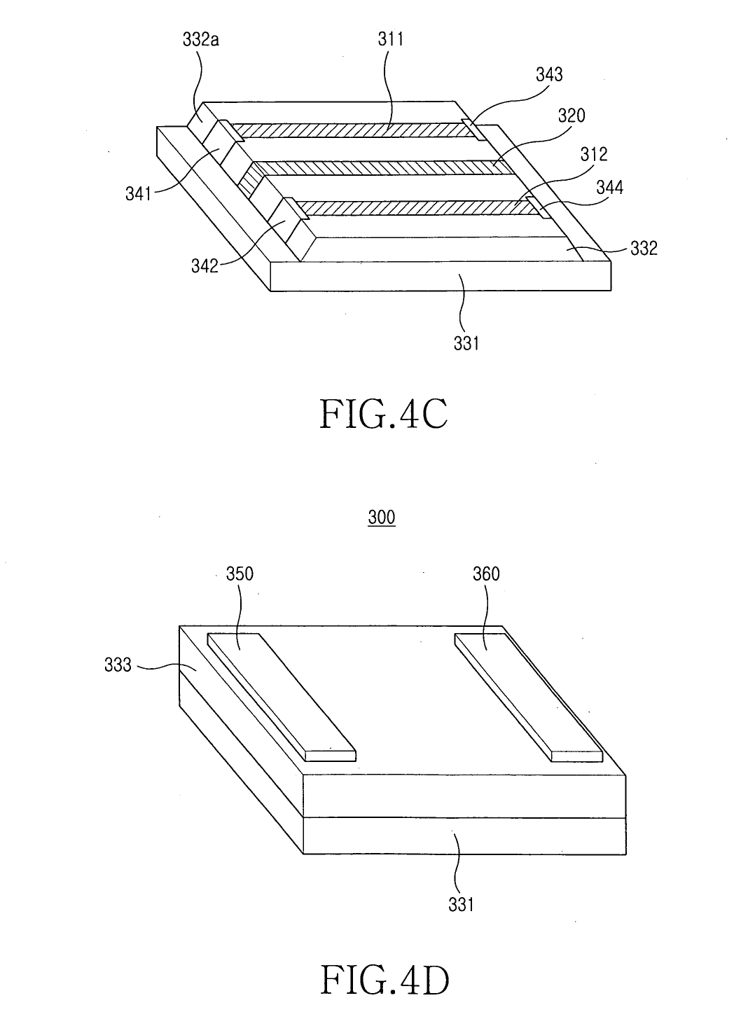

FIG. 5 is a perspective view of a planar light waveguide 300′ having second structure, which is prepared according to the manufacturing steps of FIGS. 4A to 4C. The planar light waveguide 300′ illustrated in FIG. 5 includes a substrate 331′, a clad 333′, and absorption layers 351′ and 352′ formed below the substrate 331′ and on the clad 333′. The planar light waveguide 300′ illustrated in FIG. 5 has the same structure with the planar light waveguide 300 illustrated in FIGS. 4A to 4D except for the absorption layers 351′ and 352′.

However, the absorption layer 351′ formed below the substrate 331′ is formed with open portions through which optical signals are input/ and/or output.

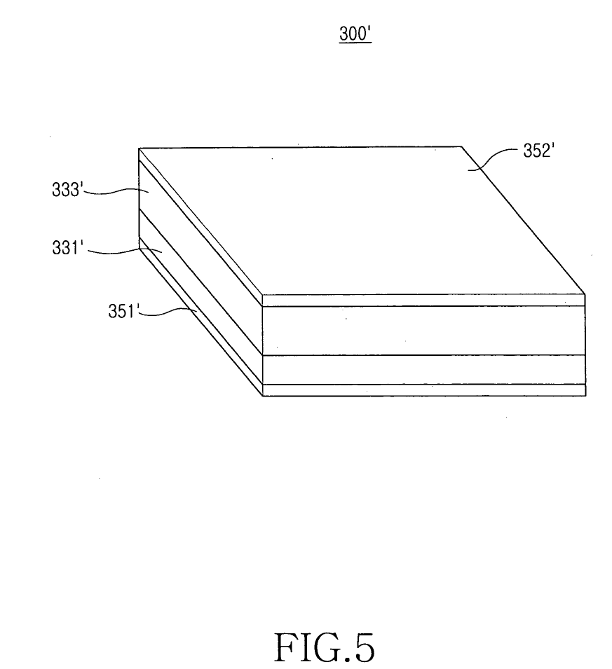

FIG. 6 is a schematic configuration of an optical transceiver 400 including a planar light waveguide according to a second preferred embodiment of the present invention. The optical transceiver 400 illustrated in FIG. 6 includes first and second light sources 431 and 432, first and second optical detectors 441 and 442, and the planar light waveguide for transmitting/receiving optical signals.

The first light source 431 generates a first optical signal 401 for carrying clock information, and the second light source 432 generates a second optical signal for carrying data. A semiconductor laser can be used for the first and second light sources 431 and 432.

The first optical detector 441 detects the clock information from the first optical signal 401, and the second optical detector 442 detects the data from the second optical signal. A photo diode can be used for the first and second optical detectors 441 and 442.

The planar light waveguide includes first and second cores 421 and 422 formed apart from each other by a predetermined distance, a dummy core 423 formed between the first and second cores 421 and 422, and a clad 410. The first core 421 transmits the first optical signal 401 from the first light source 431 to the first optical detector 441, and the second core 422 transmits the second optical signal from the second light source 432 to the second optical detector 442.

The dummy core 423 reflects an optical signal 402 incident to the adjacent clad 410 without being coupled with a relevant core 421 or 422 to a relevant optical detector 441 or 442 as an optical signal 402a, or outputs the optical signal 402 out of the light receiving range of the other optical detector 442 or 441 as an optical signal 402b.

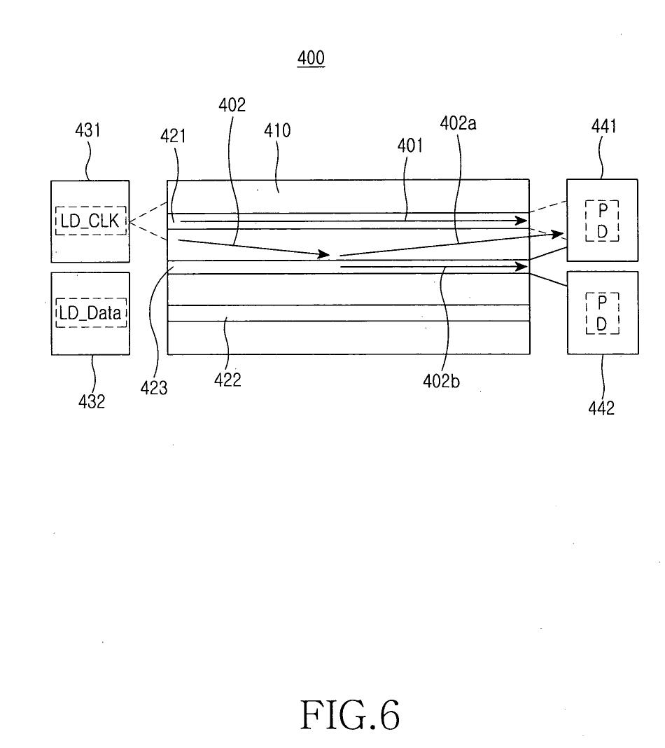

FIGS. 7A and 7B are graphs for comparing a case where an optical signal and the core of the optical fiber matches each other to a case where they do not match each other in the optical transceiver 400 of FIG. 6. In this example, the x-axis of FIGS. 7A and 7B indicates the width of the planar light waveguide, the 0 marker indicates the center of the planar light waveguide, and the z-axis indicates an optical signal traveling direction, i.e., a longitudinal direction of the planar light waveguide. A rectangular block located at a 0 μm (zero micrometers) position on the x-axis indicates the dummy core 423, a rectangular block located at a −150 to approximately −100 μm position indicates the first core 421, and a rectangular block located at a 100 to approximately 150 μm position indicates the second core 422.

FIG. 7A shows a waveform of the first optical signal 401 output from the other end of the first core 421 when the first optical signal 401 incident to one end of the first core 421 matches the center of the first core 421, and FIG. 7B shows a waveform of the first optical signal 401 output from the other end of the first core 421 when the first optical signal 401 incident to one end of the first core 421 does not match the center of the first core 421. That is, FIG. 7A shows a traveling state of the first optical signal 401 normally coupled with the first core 421, and FIG. 7B shows a state where the optical signal 402 incident to the adjacent clad 410 due to the mismatch with the center of the first core 421 is blocked by the dummy core 423, thus, not being coupled with the second core 422. As illustrated in FIGS. 7A and 7B, the interference toward the second core 422 by the first optical signal 401 can be significantly reduced by the dummy core 423.

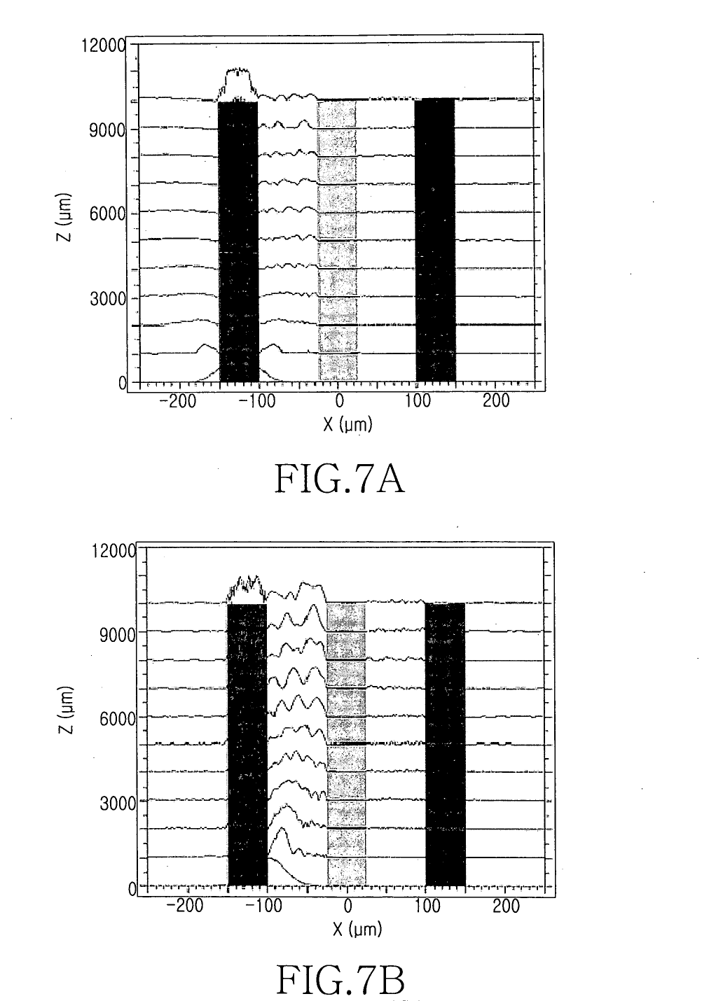

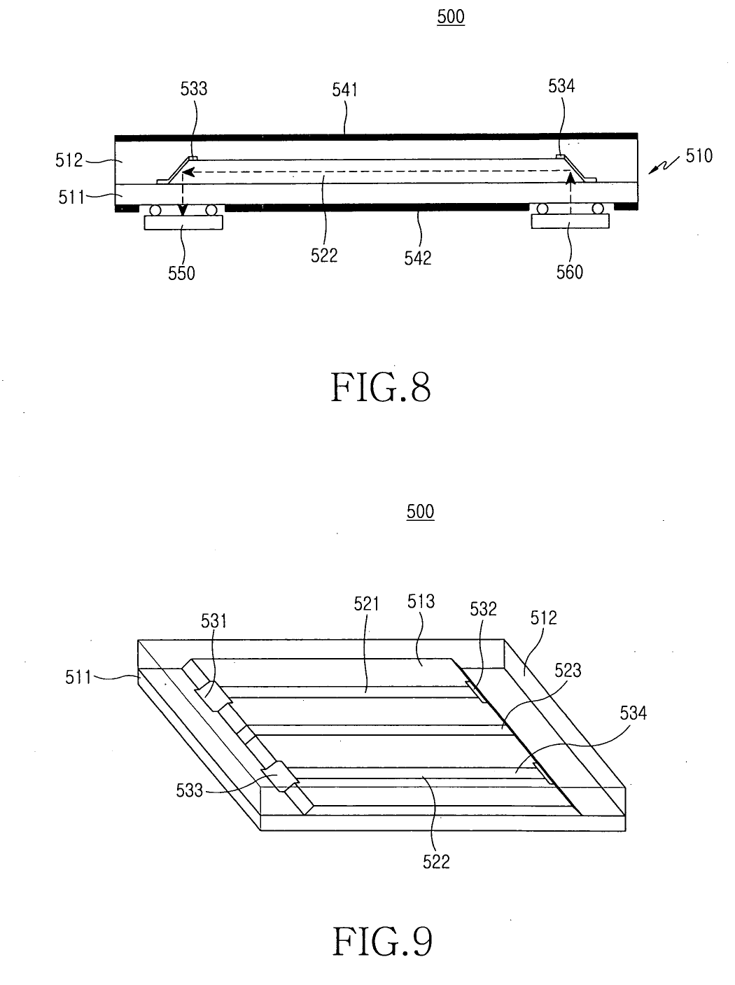

FIG. 8 is a schematic configuration of an optical transceiver 500 including a planar light waveguide 510 according to a third preferred embodiment of the present invention. FIG. 9 is a perspective view of the planar light waveguide 510 of FIG. 8. Referring to FIGS. 8 and 9, the optical transceiver 500 according to the current embodiment has an orthogonal incidence structure including the planar light waveguide 510, light sources 560, and optical detectors 550.

The planar light waveguide 510 includes a substrate 511, a plurality of cores 521 and 522, a dummy core 523 located between the cores 521 and 522, a first clad 513, a second clad 512 covering the first clad 513, and absorption layers 541 and 542.

The first clad 513 contains the plurality of cores 521 and 522, the dummy core 523 located between the cores 521 and 522, inclined planes located on the both ends thereof on which one end of the cores 521 and 522 and the dummy core 523 are exposed, and reflective mirrors 531, 532, 533, and 534 covering ends of the cores 521 and 522 exposed on the inclined planes.

The absorption layers 541 and 542 are formed on the second clad 512 and below the substrate 511, and the absorption layer 542 formed below the substrate 511 is not formed below a portion of the substrate 511 corresponding to the reflective mirrors 531, 532, 533, and 534.

In the planar light waveguide 510 according to the current embodiment, the direction of optical signals incident to the respective cores 521 and 522 is perpendicular to the direction of the optical signals traveling inside the respective cores 521 and 522. Most of the optical signals are coupled with the respective cores 521 and 522 by the respective reflective mirrors 531, 532, 533, and 534. However, a portion of the optical signals may be incident to the first clad 512 out of the respective reflective mirrors 532, and 534. That is, a portion of the optical signals, which is incident to the first clad 512 in perpendicular to the direction of the optical signals traveling inside the respective cores 521 and 522, may be incident to the other adjacent cores 521 and 522 without being blocked by the dummy core 523. Thus, in the current embodiment, the absorption layers 541 and 542 are formed on the second clad 512 and below the substrate 511 in order to absorb optical signals, which cannot be incident to the cores 521 and 522. A portion of the absorption layer 542 formed below the substrate 511 is open, and the light emitting surfaces of the light sources 560 and the light receiving surfaces of the optical detectors 550 are located in the open portion of the absorption layer 542 to optically face each other.

That is, the light emitting surfaces of the light sources 560 and the light receiving surfaces of the optical detectors 550 are located below the respective reflective mirrors 531, 532, 533, and 534 covering the ends of the respective cores 521 and 522 to optically face each other. Thus, an optical signal generated by the light source 560 is reflected by the relevant reflective mirror 534 and wave-guided to the reflective mirror 533 in the other side through the relevant core 522. The reflective mirror 533 in the other side reflects the optical signal to the relevant optical detector 550.

The inclined planes is formed to have a 45° slope in the direction of optical signals traveling inside the cores 521 and 522, and the reflective mirrors 531, 532, 533, and 534 are formed on the inclined planes, thereby having the same inclined angle 45°. The inclined angle of the inclined planes and the reflective mirrors 531, 532, 533, and 534 can be adjusted according to the needs of the optical transceiver 500.

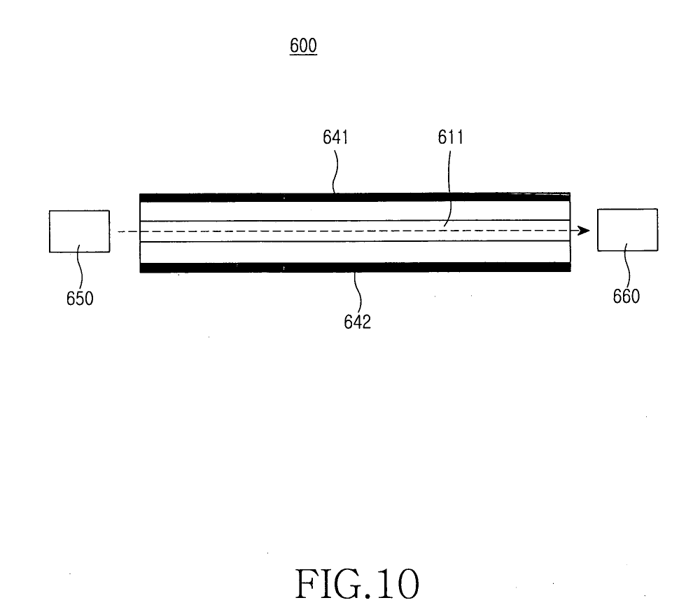

FIG. 10 is a schematic configuration of an optical transceiver 600 including a planar light waveguide according to a fourth preferred embodiment of the present invention. The optical transceiver 600 illustrated in FIG. 10 includes light sources 650, optical detectors 660, and the planar light waveguide. The planar light waveguide illustrated in FIG. 10 has a structure having a plurality of cores and a dummy core located between the cores as illustrated in FIG. 6. However, the planar light waveguide according to the current embodiment has absorption layers on a clad and below a substrate and directly outputs an optical signal incident to one end to the other end without reflective mirrors.

As described above, according to the embodiment of the present invention, crosstalk between cores can be minimized by further including a dummy core located between adjacent cores. In addition, since light emitting elements and light receiving elements can be integrated in a single chip using an array structure due to the reduction of crosstalk, the manufacturing process can be simplified, and the manufacturing cost can be reduced.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A planar light waveguide comprising:
a substrate;
at least two cores, which are formed on the substrate and are transmission media of optical signals;
a clad surrounding each of the cores for guiding the optical signals inside the cores; and
a dummy core located between the cores.

2. The planar light waveguide of claim 1, further comprising:
absorption layers formed on and below a respective clad, parallel to an optical axis along which the optical signals travel.

3. The planar light waveguide of claim 1, further comprising:
inclined planes formed on the ends of the cores and the dummy core through which optical signals are input and/or output.

4. The planar light waveguide of claim 1, wherein the width of each of the cores and the dummy core is 50 μm, and each of the cores and the dummy core are separated from each other by 100 μm.

5. The planar light waveguide of claim 3, further comprising:
reflective mirrors formed on selected ones of the inclined planes.

6. The planar light waveguide of claim 3, wherein the inclined planes are formed at a substantially 45° slope with respect to the optical axis along which the optical signals travel.

7. The planar light waveguide of claim 1, wherein the clad comprises:
a first layer in which the cores and the dummy core are formed; and
a second layer formed on the substrate to cover the first layer.

8. The planar light waveguide of claim 1, further comprising absorption layers formed on upper and lower surfaces of each of the clads.

9. A method of fabricating a planar waveguide, the method comprising the steps of:
forming a plurality of optically transparent waveguide regions separated by a known distance on a substrate;
etching a inclined surface on each end of the optically transparent waveguides; and
forming a reflective mirror on the inclined surfaces of selected ones of the optically transparent waveguide regions.

10. The method as recited in claim 9, wherein the known distance is substantially at least 100 micrometers.

11. The method as recited in claim 9, wherein the inclined surface is substantially equal to 45 degrees.

12. The method as recited in claim 9, further comprising the steps of:
forming an absorption layer above and below each of the optically transparent waveguide regions parallel to an optical axis along which optical signals travel through the optically transparent waveguide regions.

13. The method as recited in claim 9, wherein each optically transparent waveguide region is substantially 50 micrometers.

14. An optical transmission device comprising:
a signal generator providing a signal to a first optical waveguide; and
a clock generator providing a clock signal associated with the signal to a second optical waveguide, wherein the first and second optical waveguides are formed on a substrate and separated by a third optical waveguide.

15. The optical transmission device of claim 14, wherein each of the waveguides is substantially 50 micrometers.

16. The optical transmission device of claim 14, wherein each of the optical waveguides is separated by substantially 100 micrometers.

17. The optical transmission device of claim 14, wherein each of the waveguides has ends formed substantially at 45 degree angle to the direction of optical wavelength travel.

18. The optical transmission device of claim 14, wherein reflective mirrors are formed on selected ones of the waveguides.
